(19) United States
(12) Patent Application Publication
(10) Pub. No.: US 2019/0094527 A1
(43) Pub. Date: Mar. 28, 2019

(54) ROTARY DRIVE APPARATUS

(71) Applicant: Nidec Corporation, Kyoto (JP)

(72) Inventor: Yoichi SEKII, Kyoto (JP)

(21) Appl. No.: 16/104,255

(22) Filed: Aug. 17, 2018

(30) Foreign Application Priority Data
Sep. 28, 2017 (JP) 2017-188558
Sep. 28, 2017 (JP) 2017-188559

(51) Int. Cl. G02B 26/08; H02K 7/02

(52) U.S. Cl. CPC G02B 26/0816; H02K 7/02

(57) ABSTRACT

A rotary drive apparatus rotates a flywheel holding a mirror and a lens, and includes a motor and the flywheel. The flywheel is supported by the motor to rotate about a central axis extending in a vertical direction. The flywheel includes an accommodating portion including the lens. The lens includes a light-transmitting portion that allows reflected light to pass therethrough, a protective portion outside of the light-transmitting portion in lens radial directions centered on an optical axis passing through the light-transmitting portion, and a collar portion to be supported by the accommodating portion. The light-transmitting portion, the protective portion, and the collar portion are defined by a single monolithic member.

### CROSS REFERENCE TO RELATED APPLICATIONS

This application claims the benefit of priority to Japanese Patent Application No. 2017-188558 filed on Sep. 28, 2017 and Japanese Patent Application No. 2017-188559 filed on Sep. 28, 2017. The entire contents of these applications are hereby incorporated herein by reference.

### BACKGROUND OF THE INVENTION

### 1. Field of the Invention

The present invention relates to a rotary drive apparatus.

### 2. Description of the Related Art

A known scanner apparatus used for position recognition in a head-mounted display (HMD) or the like typically has installed therein optical components, such as, for example, a mirror arranged to reflect incoming light coming from a light source, and a lens arranged to allow reflected light to pass therethrough. A known apparatus including an optical component, such as, for example, a lens, is described in, for example, JP-A 2009-283021.

However, in a known optical apparatus described in JP-A 2009-283021, the lens and a base (i.e., a holder) arranged to hold the lens are defined by separate members, which may lead to an increased material cost. Further, the lens is positioned by being fitted into a recessed portion defined in the base, and is fixed to the base through an adhesive. At this time, it is necessary to grasp the lens with a human hand or a jig, and carry the lens to a predetermined position on the base. It is therefore necessary to take considerable care not to damage the lens, which may lead to a reduction in workability in assembling the apparatus.

### SUMMARY OF THE INVENTION

In view of the above circumstances, preferred embodiments of the present invention provide rotary drive apparatuses that achieve a reduced material cost and improved assembling workability.

A rotary drive apparatus according to a preferred embodiment of the present invention rotates a flywheel that holds a mirror that reflects incoming light coming from a light source, and a lens that allows reflected light obtained by reflection of the incoming light to pass therethrough. The rotary drive apparatus includes a motor and the flywheel, the flywheel being supported by the motor to rotate about a central axis extending in a vertical direction. The flywheel includes an accommodating portion in which the lens is located. The lens includes a light-transmitting portion that allows the reflected light to pass therethrough, a protective portion outside of the light-transmitting portion in lens radial directions centered on an optical axis passing through the light-transmitting portion, and a collar portion to be supported by the accommodating portion. The light-transmitting portion, the protective portion, and the collar portion are defined by a single monolithic member.

The rotary drive apparatus according to the above preferred embodiment of the present invention is able to achieve a reduced material cost because the three components of the lens are defined by a single monolithic member. Because the collar portion of the lens is easily graspable, it is easy to install the lens into the flywheel. That is, an improvement in assembling workability is achieved. Moreover, the easily graspable collar portion contributes to preventing a human hand or a jig grasping the lens from touching the light-transmitting portion when the lens is in the accommodating portion.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view of a light source, a frame, and a rotary drive apparatus according to a preferred embodiment of the present invention.

FIG. 2 is a vertical sectional view of a rotary drive apparatus according to a preferred embodiment of the present invention.

FIG. 3 is a perspective view of a flywheel according to a preferred embodiment of the present invention.

FIG. 4 is a perspective view illustrating an accommodating portion for a lens according to a preferred embodiment of the present invention.

FIG. 5 is a top view illustrating an accommodating portion for a lens according to a preferred embodiment of the present invention.

FIG. 6 is a perspective view of a lens according to a preferred embodiment of the present invention as viewed from outside a rotary drive apparatus.

FIG. 7 is a perspective view of a lens according to a preferred embodiment of the present invention as viewed from inside a rotary drive apparatus.

FIG. 8 is a vertical sectional view of a lens according to a preferred embodiment of the present invention.

FIG. 9 is a perspective view of a lens of a rotary drive apparatus according to a first modification of a preferred embodiment of the present invention.

FIG. 10 is a vertical sectional view of a lens of a rotary drive apparatus according to a second modification of a preferred embodiment of the present invention.

### DETAILED DESCRIPTION OF THE PREFERRED EMBODIMENTS

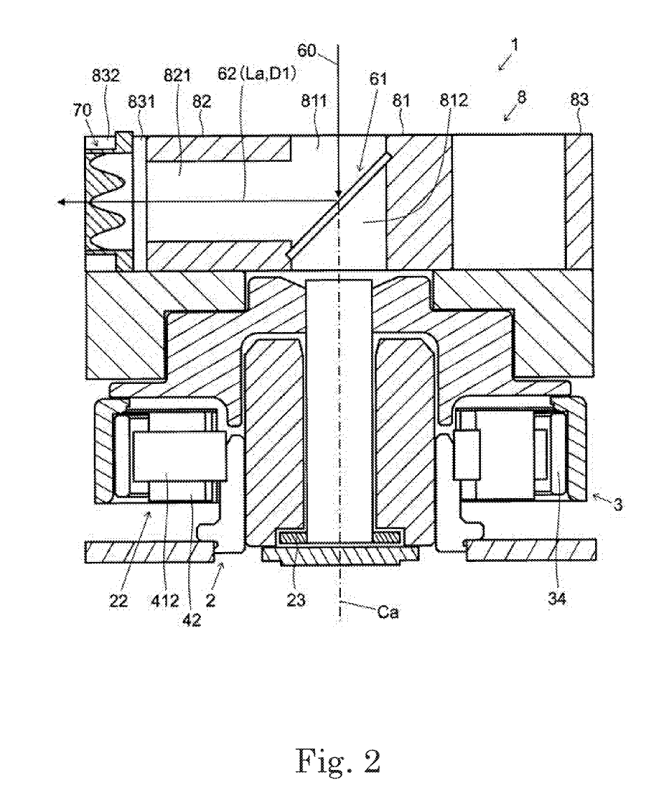

Hereinafter, preferred embodiments of the present invention will be described in detail with reference to the accompanying drawings. It is assumed herein that a direction in which a central axis of a motor of a rotary drive apparatus extends is referred to simply by the term “axial direction”, “axial”, or “axially”, that directions perpendicular to the central axis of the motor and centered on the central axis are each referred to simply by the term “radial direction”, “radial”, or “radially”, and that a direction along a circular arc centered on the central axis of the motor is referred to simply by the term “circumferential direction”, “circumferential”, or “circumferentially”. It is also assumed herein that an axial direction is a vertical direction for the sake of convenience in description, and the shape of each member or portion and relative positions of different members or portions will be described on the assumption that a vertical direction and upper and lower sides in FIG. 2 are a vertical direction and upper and lower sides of the rotary drive apparatus. It should be noted, however, that the above definition of the vertical direction and the upper and lower sides is not meant to restrict in any way the orientation of, or relative positions of different members or portions of, a rotary drive apparatus according to any preferred embodiment of the present invention when in use.

It is also assumed herein that, regarding a lens of a rotary drive apparatus, a direction in which an optical axis passing through the lens extends is referred to as an “optical axis direction”, and that directions perpendicular to the optical axis and centered on the optical axis are each referred to as a “lens radial direction”. The shape of each portion of the lens and relative positions of different portions of the lens will be described based on the above assumption. It is also assumed herein that a sectional view parallel to the axial direction is referred to as a “vertical sectional view”. Note that the wordings “parallel”, “at right angles”, “perpendicular”, etc., as used herein include not only “exactly parallel”, “exactly at right angles”, “exactly perpendicular”, etc., respectively, but also “substantially parallel”, “substantially at right angles”, “substantially perpendicular”, etc., respectively.

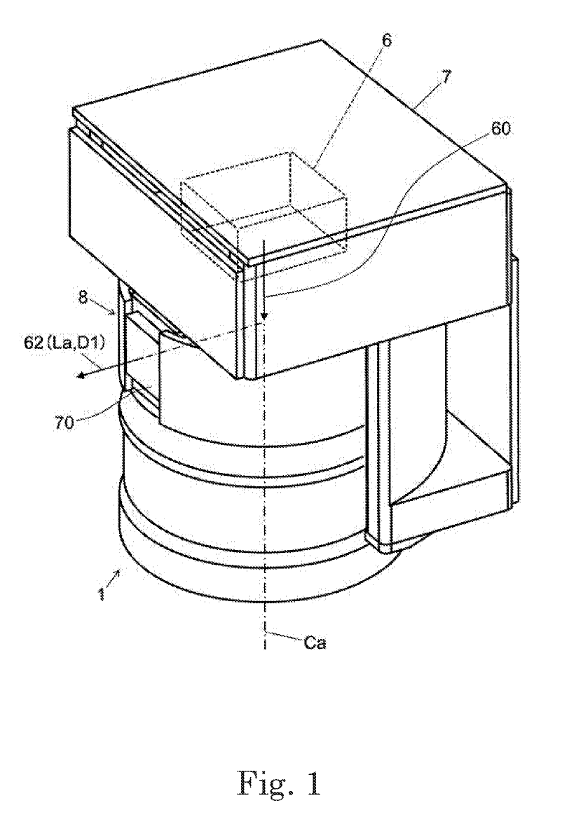

FIG. 1 is a perspective view of a light source 6, a frame 7, and a rotary drive apparatus 1 according to a preferred embodiment of the present invention. Referring to FIG. 1, the rotary drive apparatus 1 is an apparatus arranged to rotate a flywheel 8 that holds optical components each of which is arranged to reflect incoming light 60 coming from the light source 6 in a radial direction (i.e., a first radial direction D1) or allow the incoming light 6 to pass therethrough. The optical components include a lens 70 and a mirror 61 (see FIG. 2).

The frame 7 is arranged above the rotary drive apparatus 1. The frame 7 is fixed to a casing or the like in which the rotary drive apparatus 1 is arranged. The light source 6 is installed in the frame 7.

The light source 6 is arranged to emit the incoming light 60, which travels downward along a central axis Ca of a motor 10. In the present preferred embodiment, each of the light source 6 and the frame 7 is arranged outside of the rotary drive apparatus 1. Note, however, that each of the light source 6 and the frame 7 may alternatively be included in the rotary drive apparatus 1.

The rotary drive apparatus 1 includes the motor 10, the flywheel 8, and the optical components (i.e., the lens 70 and the mirror 61) held by the flywheel 8.

FIG. 2 is a vertical sectional view of the rotary drive apparatus 1 according to a preferred embodiment of the present invention. Referring to FIG. 2, the motor 10 includes a stationary portion 2 including a stator 22, and a rotating portion 3 including a magnet 34. The stationary portion 2 is arranged to be stationary relative to the casing or the like in which the rotary drive apparatus 1 is arranged. The rotating portion 3 is supported through a bearing portion 23 to be rotatable about the central axis Ca, which extends in the vertical direction, with respect to the stationary portion 2.

Once electric drive currents are supplied to coils 42 included in the stationary portion 2, magnetic flux is generated around each of a plurality of teeth 412, which are magnetic cores for the coils 42. Then, interaction between the magnetic flux of the teeth 412 and magnetic flux of the magnet 34 included in the rotating portion 3 produces a circumferential torque between the stationary portion 2 and the rotating portion 3. As a result, the rotating portion 3 is caused to rotate about the central axis Ca with respect to the stationary portion 2. Thus, the flywheel 8, which is rotatably supported by the rotating portion 3, is caused to rotate about the central axis Ca together with the rotating portion 3.

As the bearing portion 23, a fluid dynamic bearing, in which a portion of the stationary portion 2 and a portion of the rotating portion 3 are arranged opposite to each other with a gap in which a lubricating oil exists therebetween and which is arranged to induce a fluid dynamic pressure in the lubricating oil, is used, for example. Note that a bearing of another type, such as, for example, a rolling-element bearing, may alternatively be used as the bearing portion 23.

Referring to FIG. 2, the flywheel 8 is supported by an upper end portion of the rotating portion 3 of the motor 10, and is arranged to rotate about the central axis Ca together with the rotating portion 3. The flywheel 8 is fixed to an upper surface of the rotating portion 3 through, for example, an adhesive or the like.

The flywheel 8 holds each of the mirror 61 and the lens 70. A resin, for example, is used as a material of the flywheel 8. Glass, for example, is used as materials of the mirror 61 and the lens 70. The glass is not limited to particular types of glass. For example, organic glass, inorganic glass, a resin, or a metal may be used as the materials of the mirror 61 and the lens 70, but other materials may alternatively be used.

The mirror 61 is in the shape of a plate, and is arranged to have a rectangular or circular external shape. The mirror 61 is fixed to a resin member of the flywheel 8, and at least a portion of the mirror 61 is arranged on the central axis Ca. A reflecting surface of the mirror 61 is inclined at an angle of 45 degrees with respect to the axial direction and the first radial direction D1. A fully reflective mirror, for example, is used as the mirror 61. The incoming light 60 impinges on a central portion of the mirror 61. The central portion of the mirror 61 refers to the entire mirror 61, excluding a peripheral portion of the mirror 61. The incoming light 60 is reflected by the mirror 61 inside of the flywheel 8, and is changed in the direction of travel. Note that, instead of the mirror 61, a prism (not shown) or the like may alternatively be used to change the direction of travel of the incoming light 60.

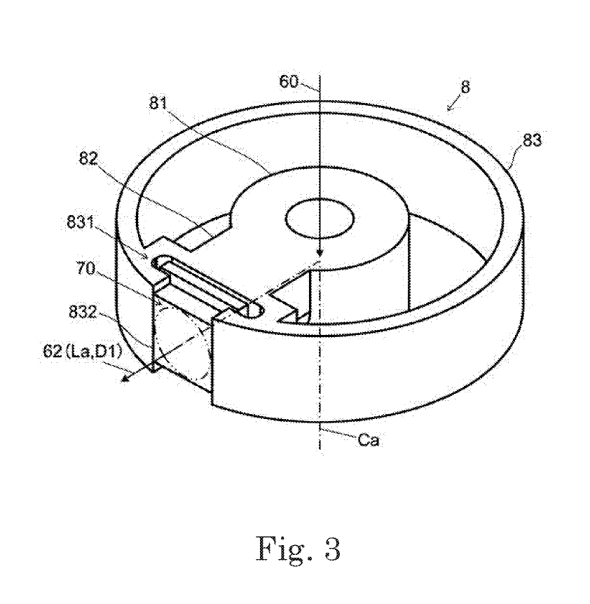

FIG. 3 is a perspective view of the flywheel 8 according to a preferred embodiment of the present invention. Referring to FIGS. 2 and 3, the flywheel 8 includes a vertical cylindrical portion 81, a horizontal cylindrical portion 82, and an outer cylindrical portion 83. In the present preferred embodiment, the vertical cylindrical portion 81, the horizontal cylindrical portion 82, and the outer cylindrical portion 83 are defined as a single monolithic member by a resin injection molding process. Note, however, that the vertical cylindrical portion 81, the horizontal cylindrical portion 82, and the outer cylindrical portion 83 may alternatively be defined by separate members.

The vertical cylindrical portion 81 is a cylindrical portion arranged to extend in the vertical direction along the axial direction in a radial center of the flywheel 8. The vertical cylindrical portion 81 has a cavity 811 defined radially inside thereof. The cavity 811 is arranged to extend in the vertical direction in parallel with the central axis Ca. The cavity 811 defines a light path.

The horizontal cylindrical portion 82 is a cylindrical portion arranged to extend radially outward in the radial direction (i.e., the first radial direction D1) from an outer circumferential portion of the vertical cylindrical portion 81. The horizontal cylindrical portion 82 has a cavity 821 defined inside thereof. The cavity 821 is arranged to extend in the radial direction perpendicularly to the central axis Ca. The cavity 821 is joined to the cavity 811 at right angles. The cavity 821 is arranged to overlap with each of the mirror 61 and the lens 70 when viewed in the first radial direction D1. The cavity 821 defines a light path.

The mirror 61 is fixed at a region at which the cavity 811 and the cavity 821 intersect with each other. In addition, the vertical cylindrical portion 81 has a cavity 812 below the region at which the mirror 61 is fixed. The cavity 812 is arranged to extend in the vertical direction in parallel with the central axis Ca. A portion of the incoming light 60 may alternatively be allowed to pass through the mirror 61 and then travel downward through the cavity 812.

The outer cylindrical portion 83 is a cylindrical portion arranged to extend in the vertical direction along the central axis Ca radially outside of the vertical cylindrical portion 81 and the horizontal cylindrical portion 82. An outer circumferential surface of the outer cylindrical portion 83 defines at least a portion of an outer circumferential surface of the flywheel 8. A radially outer end portion of the horizontal cylindrical portion 82 is joined to an inner circumferential surface of the outer cylindrical portion 83. Meanwhile, an outer circumferential surface of the vertical cylindrical portion 81 is joined to a radially inner end portion of the horizontal cylindrical portion 82. The outer cylindrical portion 83 has an accommodating portion 831 at a portion thereof to which the radially outer end portion of the horizontal cylindrical portion 82 is joined. The lens 70 is arranged in the accommodating portion 831. The structure of the accommodating portion 831 will be described in detail below.

The lens 70 is arranged to have an external shape being rectangular or circular when viewed in the optical axis direction passing through the lens 70. The lens 70 is accommodated in the accommodating portion 831, and is held by the flywheel 8, including the outer cylindrical portion 83. The lens 70 is arranged at right angles to the first radial direction D1 in the accommodating portion 831, and is arranged in parallel with the central axis Ca. An opening at a radially outer end portion of the cavity 821 of the horizontal cylindrical portion 82 is covered by the lens 70. The structure of the lens 70 will be described in detail below.

In the present preferred embodiment, the incoming light 60, which is emitted from the light source 6, enters the flywheel from above an upper surface of the flywheel 8, and travels downward along the central axis Ca in the cavity 811 of the vertical cylindrical portion 81. The incoming light 60 is reflected by the mirror 61 inside of the vertical cylindrical portion 81 to become reflected light 62. The reflected light 62 travels outward in the first radial direction D1 in the cavity 821 of the horizontal cylindrical portion 82, and is emitted out of the rotary drive apparatus 1 through the lens 70.

The mirror 61 of the flywheel 8 is arranged to reflect the incoming light 60 coming from the light source 6 and emit the reflected light 62 to an outside of the rotary drive apparatus 1 while rotating about the central axis Ca together with the rotating portion 3 of the motor 10. Thus, a wide range can be irradiated with light. The rotation speed of the rotary drive apparatus 1 can be recognized by sensing the reflected light 62, which is emitted out of the flywheel 8, using an external sensor (not shown). Note that the outer circumferential surface of the flywheel 8 has a light reflectivity lower than that of a front surface of the mirror 61. This contributes to preventing diffuse reflection of the incoming light 60 coming from the light source 6.

Note that the rotary drive apparatus 1 may further include, in addition to the flywheel 8 arranged to emit the reflected light 62 to the outside in the first radial direction D1, another flywheel (not shown) which is arranged to emit reflected light to the outside in a second radial direction different from the first radial direction D1, and which is arranged, for example, below the motor 10. In this case, a half mirror the transmissivity and reflectivity of which are substantially equal is used as the mirror 61. Then, a half of the incoming light 60 which impinges on the mirror 61 in the flywheel 8 is caused to be reflected in the first radial direction D1 to be emitted to the outside. A remaining half of the incoming light 60 which impinges on the mirror 61 is allowed to pass through the mirror 61 and further travel downward through the cavity 812 of the vertical cylindrical portion 81. A through hole (not shown) passing through the motor 10 in the axial direction is defined around the central axis Ca in the motor 10. The portion of the incoming light 60 which has passed through the mirror 61 passes through the through hole and reaches the other flywheel arranged below the motor 10. Then, the portion of the incoming light 60 which has reached the other flywheel is caused to be reflected in the second radial direction to be emitted to the outside, using a fully reflective mirror (not shown) in the other flywheel. Note that a plurality of mirrors (not shown), including a half mirror, which are arranged to reflect the incoming light 60 in mutually different directions may alternatively be installed in the single flywheel 8 of the rotary drive apparatus 1.

When light is emitted out in the two different directions, i.e., the first radial direction D1 and the second radial direction, as described above, light beams that are emitted out in the two different directions take different times to reach an object to be irradiated with light while the motor 10 is running, and this makes it possible to precisely recognize the three-dimensional position of the object in a space. Note that the other flywheel may alternatively be arranged in a rotary drive apparatus (not shown) other than the rotary drive apparatus 1 including the flywheel 8.

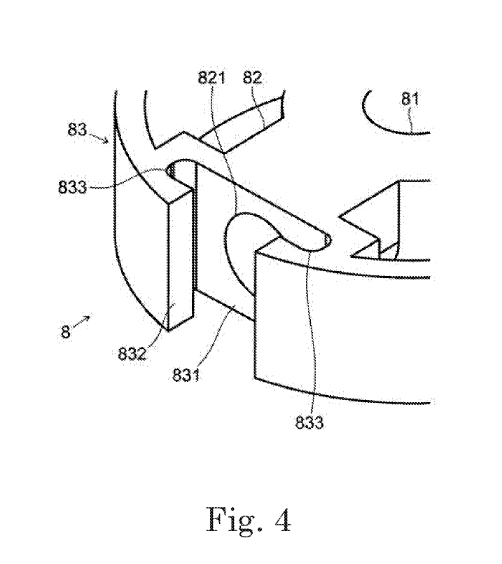

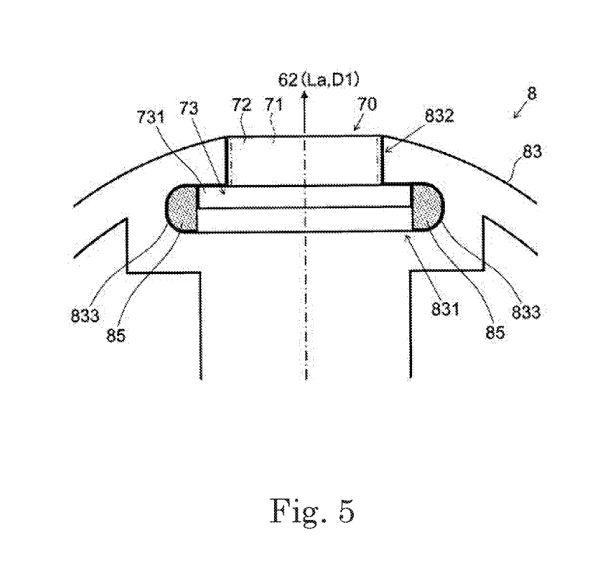

FIG. 4 is a perspective view illustrating the accommodating portion 831 for the lens 70 according to a preferred embodiment of the present invention. FIG. 5 is a top view illustrating the accommodating portion 831 for the lens 70 according to a preferred embodiment of the present invention. In FIG. 4, the lens 70 is not shown. Referring to FIGS. 4 and 5, the accommodating portion 831 is a cavity substantially in the shape of a rectangular parallelepiped, extending at right angles to the first radial direction D1, which is the direction of travel of the reflected light 62. An upper end portion of the accommodating portion 831 is exposed axially upwardly of the flywheel 8. A lower end portion of the accommodating portion 831 is exposed axially downwardly of the flywheel 8. The dimension of an interior of the accommodating portion 831 measured in the first radial direction D1 is greater than the thickness of the lens 70 measured in the first radial direction D1.

The accommodating portion 831 has an opening portion 832. The opening portion 832 is arranged at an edge portion of the accommodating portion 831 on an outer side in the first radial direction D1. The opening portion 832 is arranged to pass through the outer cylindrical portion 83 in the first radial direction D1 to open into the outside of the flywheel 8. An upper end portion of the opening portion 832 is exposed axially upwardly of the flywheel 8. A lower end portion of the opening portion 832 is exposed axially downwardly of the flywheel 8. The dimension of the opening portion 832 measured in a lateral direction (i.e., a circumferential direction), which is perpendicular to each of the first radial direction D1 and the axial direction, is smaller than the dimension of the accommodating portion 831 measured in the lateral direction (i.e., the circumferential direction), which is perpendicular to each of the first radial direction D1 and the axial direction.

In the accommodating portion 831, the lens 70 is arranged at right angles to the first radial direction D1. At this time, a portion of the lens 70 is arranged in the opening portion 832. The lens 70 is inserted into the accommodating portion 831 and the opening portion 832 along the axial direction from above or below the flywheel 8. The axial dimension of each of the accommodating portion 831 and the opening portion 832 is substantially equal to the axial dimension of the lens 70. The arrangement of the lens 70 in the accommodating portion 831 will be described in detail below.

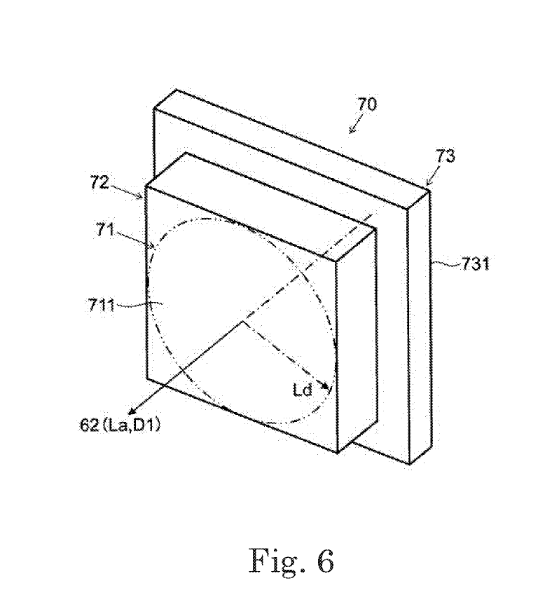

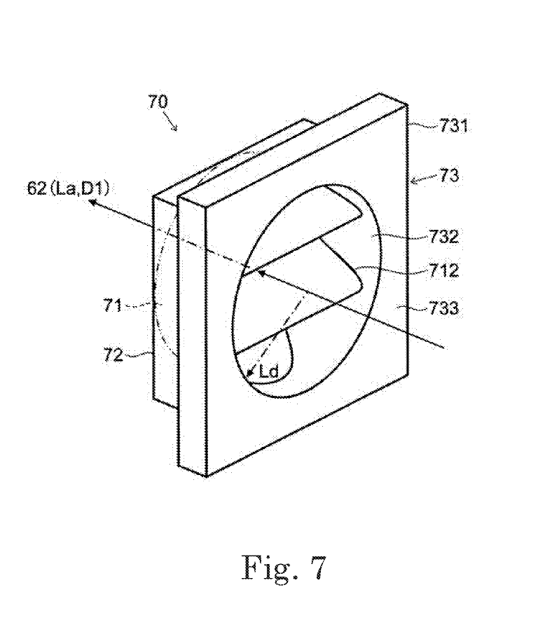

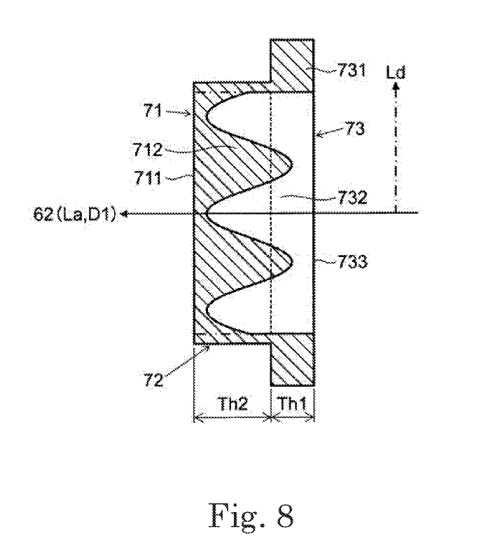

FIG. 6 is a perspective view of the lens 70 according to a preferred embodiment of the present invention as viewed from outside the rotary drive apparatus 1. FIG. 7 is a perspective view of the lens 70 according to a preferred embodiment of the present invention as viewed from inside the rotary drive apparatus 1. FIG. 8 is a vertical sectional view of the lens 70 according to a preferred embodiment of the present invention. Referring to FIGS. 3 and 6, the lens 70 is arranged at right angles to an optical axis La passing through the lens 70. Note that the optical axis direction, in which the optical axis La passing through the lens 70 extends, coincides with the first radial direction D1. In the following description of the structure of the lens 70, the term “optical axis direction (D1)” is used as appropriate to describe the shapes of various portions of the lens 70 and relative positions of different portions of the lens 70.

The lens 70 includes a light-transmitting portion 71, a protective portion 72, and a collar portion 73.

The light-transmitting portion 71 is arranged to extend in lens radial directions Ld, which are perpendicular to the optical axis La, with the optical axis La as a center. The light-transmitting portion 71 is a portion arranged to allow the reflected light 62 to pass therethrough. The light-transmitting portion 71 is arranged to have an external shape being circular when viewed in the optical axis direction (D1), and is arranged to have a predetermined thickness in the optical axis direction (D1). The light-transmitting portion 71 includes an outer surface 711 on the side toward which the reflected light 62 is emitted (i.e., an outer side in the optical axis direction (D1)). The outer surface 711 is a flat surface extending in the lens radial directions Ld. The light-transmitting portion 71 has a curved and striped relief structure 712 on the side from which the reflected light 62 comes (i.e., an inner side in the optical axis direction (D1)).

The protective portion 72 is arranged outside of the light-transmitting portion 71 in the lens radial directions Ld. The protective portion 72 is a portion that does not allow the reflected light 62 to pass therethrough. The external shape of the protective portion 72 is in the shape of a rectangular parallelepiped, and the protective portion 72 is arranged to have a predetermined thickness in the optical axis direction (D1).

Referring to FIG. 5, a portion of the lens 70, including the protective portion 72, is arranged in the opening portion 832 when the lens 70 is arranged in the accommodating portion 831. The dimension of the protective portion 72 measured in the lateral direction (i.e., the circumferential direction), which is perpendicular to each of the optical axis direction (D1) and the axial direction, is substantially equal to the dimension of the opening portion 832 measured in the lateral direction (i.e., the circumferential direction), which is perpendicular to each of the optical axis direction (D1) and the axial direction. The thickness of the protective portion 72 measured in the optical axis direction (D1) is substantially equal to the thickness of a portion of the outer cylindrical portion 83 around the opening portion 832 measured in the optical axis direction (D1).

The collar portion 73 is arranged on the side (i.e., the inner side in the optical axis direction (D1)) of the protective portion 72 from which the reflected light 62 comes. The collar portion 73 is a portion that does not allow the reflected light 62 to pass therethrough. The external shape of the collar portion 73 is in the shape of a rectangular parallelepiped, and the collar portion 73 is arranged to have a predetermined thickness in the optical axis direction (D1). The collar portion 73 includes a projecting portion 731. The projecting portion 731 does not overlap with the protective portion 72 when viewed in the optical axis direction (D1) of the lens 70, and projects outward in the lens radial directions Ld relative to an outer edge portion of the protective portion 72.

In addition, when the lens 70 is arranged in the accommodating portion 831, the projecting portion 731 of the collar portion 73 of the lens 70 is brought into contact with the outer cylindrical portion 83. At this time, an outer surface of the projecting portion 731 which lies on the outer side in the optical axis direction (D1) is brought into contact with an inner surface of the outer cylindrical portion 83. Each of the outer surface of the projecting portion 731 which lies on the outer side in the optical axis direction (D1) and a portion of the inner surface of the outer cylindrical portion 83 which is in contact with the outer surface of the projecting portion 731 is a flat surface. Thus, the lens 70 is positioned with respect to the optical axis direction (D1) in the accommodating portion 831.

In addition, the accommodating portion 831 further has pockets 833. Each pocket 833 is arranged adjacent to the lens 70 in the accommodating portion 831 in the lateral direction (i.e., the circumferential direction), which is perpendicular to each of the optical axis direction (D1) and the axial direction. The pocket 833 is a space extending in the vertical direction, i.e., in the axial direction. The pocket 833 is arranged to accommodate an adhesive 85 therein. The adhesive 85 is used to fix the lens 70 in the accommodating portion 831. That is, the collar portion 73 of the lens 70 is supported by the accommodating portion 831.

In the lens 70 having the above-described structure, the light-transmitting portion 71, the protective portion 72, and the collar portion 73 are defined by a single monolithic member. A reduction in a material cost can be achieved by the above three components of the lens 70 being defined by a single monolithic member. In addition, because the collar portion 73 of the lens 70 is easily graspable, it is easy to install the lens 70 into the flywheel 8. That is, an improvement in assembling workability can be achieved. Moreover, the easily graspable collar portion 73 contributes to preventing a human hand or a jig grasping the lens 70 from touching the light-transmitting portion 71 when the lens 70 is arranged in the accommodating portion 831.

Further, the projecting portion 731 included in the collar portion 73 makes it still easier to grasp the collar portion 73.

In addition, referring to FIGS. 7 and 8, the collar portion 73 has a through hole 732. The through hole 732 is arranged to overlap or coincide with the light-transmitting portion 71 when viewed in the optical axis direction (D1) of the lens 70, and is arranged to pass through the collar portion 73 in the optical axis direction (D1) of the lens 70. A portion of the relief structure 712, which is a portion of the light-transmitting portion 71, is accommodated in the through hole 732. This prevents a portion of the light-transmitting portion 71 from protruding radially inward from an inner surface 733 of the collar portion 73. The inner surface 733 lies on the side (i.e., the inner side in the optical axis direction (D1)) of the collar portion 73 from which the reflected light 62 comes. The light-transmitting portion 71 can thus be protected.

In addition, referring to FIG. 8, the thickness Th1 of the collar portion 73 measured in the optical axis direction (D1) of the lens 70 is smaller than the thickness Th2 of the protective portion 72 measured in the optical axis direction (D1). Thus, the thickness of the lens 70 measured in the optical axis direction (D1) can be minimized while providing the collar portion 73. This will lead to a reduction in the amount of a material used for the rotary drive apparatus 1.

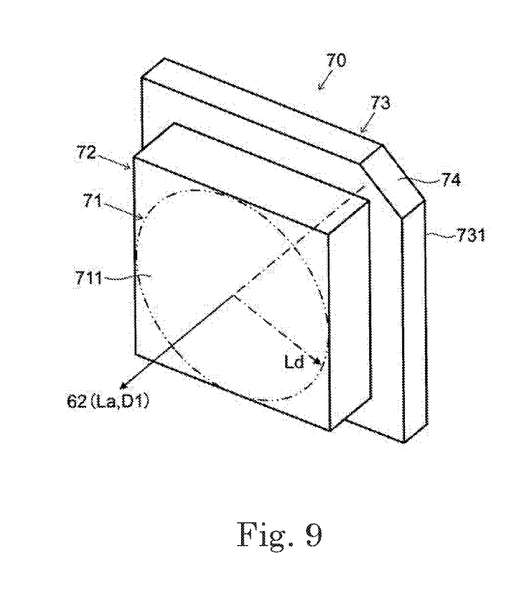

FIG. 9 is a perspective view of a lens 70 of a rotary drive apparatus 1 according to a first modification of the above-described preferred embodiment of the present invention. Referring to FIG. 9, the lens 70 has a cut portion 74. At least one of a protective portion 72 and a collar portion 73 has the cut portion 74. For example, the collar portion 73 has the cut portion 74. In a projecting portion 731 of the collar portion 73, the cut portion 74 is recessed inward from an outer surface of the collar portion 73. More specifically, a corner portion of the projecting portion 731 is chamfered to define the cut portion 74.

With the above configuration, the cut portion 74 serves as a guide to indicate a direction in which the lens 70 is to be inserted when the lens 70 is arranged in an accommodating portion 831. This makes it easy to grasp the direction in which the lens 70 is to be inserted into the accommodating portion 831. This in turn can lead to an improvement in workability in assembling the rotary drive apparatus 1.

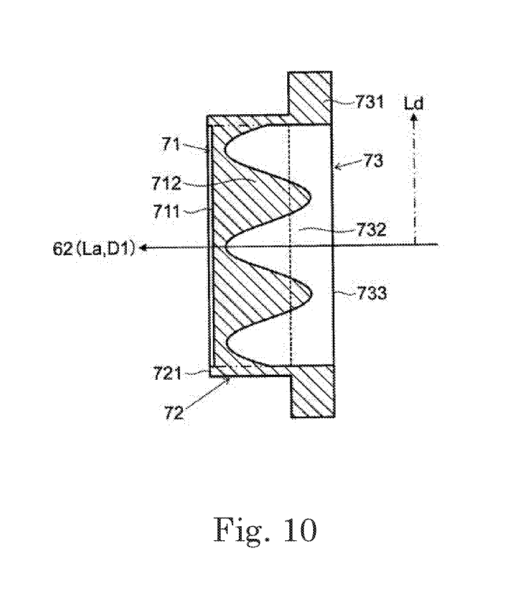

FIG. 10 is a vertical sectional view of a lens 70 of a rotary drive apparatus 1 according to a second modification of the above-described preferred embodiment of the present invention. Referring to FIG. 10, a light-transmitting portion 71 of the lens 70 includes an outer surface 711 on the side toward which reflected light 62 is emitted (i.e., the outer side in the optical axis direction (D1)). The outer surface 711 is a flat surface extending in the lens radial directions Ld. A protective portion 72 of the lens 70 includes an outer surface 721 on the side toward which the reflected light 62 is emitted (i.e., the outer side in the optical axis direction (D1)). The outer surface 721 is a flat surface extending in the lens radial directions Ld. In addition, the outer surface 721 of the protective portion 72 is arranged to project outward in the optical axis direction (D1) relative to the outer surface 711 of the light-transmitting portion 71.

The above configuration leads to improved protection of the light-transmitting portion 71. Further, it is made easier to recognize the region of the light-transmitting portion 71 than in the case where the outer surface 721 of the protective portion 72 and the outer surface 711 of the light-transmitting portion 71 are flush with each other. Therefore, the above configuration contributes to preventing a human hand or a jig grasping the lens 70 from touching the light-transmitting portion 71.

While preferred embodiments of the present invention have been described above, it will be understood that the scope of the present invention is not limited to the above-described preferred embodiments, and that various modifications may be made to the above-described preferred embodiments without departing from the gist of the present invention. In addition, features of the above-described preferred embodiments and the modifications thereof may be combined appropriately as desired.

In the above-described preferred embodiment, the lens 70 is fixed in the accommodating portion 831 through the adhesive 85 injected into the pockets 833 of the accommodating portion 831. Note, however, that the lens 70 may not necessarily be fixed in the accommodating portion 831 by this method. For example, the lens 70 may alternatively be fixed in the accommodating portion 831 through press fitting. Further, the lens 70 may alternatively be fixed in the accommodating portion 831 through welding or screwing.

Preferred embodiments of the present invention are applicable to, for example, rotary drive apparatuses.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A rotary drive apparatus that rotates a flywheel holding a mirror that reflects incoming light coming from a light source, and a lens that allows reflected light obtained by reflection of the incoming light to pass therethrough, the rotary drive apparatus comprising:
a motor; and
the flywheel; wherein
the flywheel is supported by the motor to rotate about a central axis extending in a vertical direction;
the flywheel includes an accommodating portion in which the lens is located;
the lens includes:
a light-transmitting portion that allows the reflected light to pass therethrough;
a protective portion outside of the light-transmitting portion in lens radial directions centered on an optical axis passing through the light-transmitting portion; and
a collar portion to be supported by the accommodating portion; and
the light-transmitting portion, the protective portion, and the collar portion are defined by a single monolithic member.

2. The rotary drive apparatus according to claim 1, wherein the collar portion includes a projecting portion not overlapping with the protective portion when viewed in an optical axis direction in which the optical axis extends, and projecting outward in the lens radial directions relative to an outer edge portion of the protective portion.

3. The rotary drive apparatus according to claim 1, wherein
the collar portion includes a through hole overlapping or coinciding with the light-transmitting portion when viewed in an optical axis direction in which the optical axis extends, and is able to pass through the collar portion in the optical axis direction; and
a portion of the light-transmitting portion is accommodated in the through hole.

4. The rotary drive apparatus according to claim 1, wherein a thickness of the collar portion measured in an optical axis direction in which the optical axis extends is smaller than a thickness of the protective portion measured in the optical axis direction.

5. The rotary drive apparatus according to claim 1, wherein at least one of the protective portion and the collar portion includes a cut portion recessed inward from an outer surface thereof.

6. The rotary drive apparatus according to claim 1, wherein
the light-transmitting portion includes an outer surface extending in the lens radial directions; and
the protective portion includes an outer surface extending in the lens radial directions, and projects outward in an optical axis direction in which the optical axis extends relative to the outer surface of the light-transmitting portion.
